(19) United States
(12) Patent Application Publication
(10) Pub. No.: US 2018/0091588 A1
(43) Pub. Date: Mar. 29, 2018

(54) BALANCING WORKLOAD ACROSS NODES IN A MESSAGE BROKERING CLUSTER

(71) Applicant: LinkedIn Corporation, Mountain View, CA (US)

(72) Inventors: Jiangjie Qin, Sunnyvale, CA (US); Aditya A. Auradkar, Fremont, CA (US); Adem Efe Gencer, Ithaca, NY (US); Joel J. Koshy, Sunnyvale, CA (US); Kartik Paramasivam, Sunnyvale, CA (US)

(73) Assignee: LinkedIn Corporation, Mountain View, CA (US)

(21) Appl. No.: 15/276,124

(22) Filed: Sep. 26, 2016

(51) Int. Cl. H04L 29/08

(52) U.S. Cl. CPC H04L 67/1012; H04L 67/1095

(57) ABSTRACT

A system, apparatus, and methods are provided for balancing partition distribution across nodes within a message broker cluster so as to balance the broker nodes' workloads. During operation, the system receives a stream of messages at the cluster, wherein the message stream is divided into topics, the topics are divided into partitions, and replicas for each partition are distributed among the nodes of the message brokering cluster. Upon detection of an imbalance in the nodes' workloads by a monitor (e.g., as indicated by uneven resource consumption), an analyzer considers various possible remedies (e.g., reassigning/demoting/promoting a replica), estimates their likely impacts on the workload, and determines whether they satisfy hard and/or soft goals of the system. The analyzer generates a plan that satisfies the hard goals and that may satisfy some or all soft goals, and passes it to an executor for implementation.

### RELATED APPLICATION

The subject matter of this application is related to the subject matter in co-pending U.S. patent application Ser. No. ______, entitled “Self-Healing a Message Brokering Cluster” (Attorney Docket LI-P1922), which was filed even date herewith and is incorporated herein by reference.

### BACKGROUND

### Field

The disclosed embodiments relate to message broker clusters. More particularly, a system, apparatus, and methods are provided for balancing the workload of nodes within a message broker cluster.

### Related Art

To deal with a flow of data (e.g., a message stream) that is too large to be handled by a single server, an organization that processes the data may employ a server cluster that shares the burden of handling the message stream among multiple servers by dividing the message stream into a set of parts and having each server handle a subset of the parts. In doing so, the organization may improve its ability to provision data-intensive online services aimed at large groups of users.

However, if one of the servers within the cluster becomes unreachable in some way (e.g., crashes), the cluster's ability to handle the message stream may degrade in terms of throughput, reliability, and/or redundancy. More particularly, the loss of a single server within the cluster may jeopardize a portion of the data received via the message stream (i.e., the part of the message stream handled by the lost server).

Additionally, the distribution of work associated with handling the messages, across the servers of the cluster, may be unbalanced due to the addition of a new server, the loss of an existing server, a change in the amount of message traffic, and/or for some other reason. In order to avoid overtaxing one or more servers, it may be beneficial to spread the workload more evenly.

Hence, what is needed is a system that enables clusters to handle large data streams without the above-described problems.

### BRIEF DESCRIPTION OF THE FIGURES

FIG. 1 shows a schematic of a computing environment in accordance with the disclosed embodiments.

FIGS. 2A-2D show a system that self-heals across nodes within a message broker cluster, in accordance with the disclosed embodiments.

FIGS. 3A-3E show a system that balances partition distribution across nodes within a message broker cluster in accordance with the disclosed embodiments.

FIG. 4 shows a flowchart illustrating an exemplary process of healing a message broker cluster, in accordance with the disclosed embodiments.

FIG. 5 shows a flowchart illustrating an exemplary process of balancing partition distribution within a message broker cluster, in accordance with the disclosed embodiments.

FIG. 6 shows a flowchart illustrating an exemplary process of migrating a set of replicas one chunk at a time within a message broker cluster, in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, flash storage, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method, apparatus, and system that enable self-healing and balanced partition distribution across nodes within a message broker cluster (e.g., balanced in terms of resource utilization, balanced in terms of numbers of partitions or partition replicas). More specifically, the disclosed embodiments provide a method, apparatus, and system that facilitate the migration of one or more partition replicas between the nodes of the message broker cluster in response to a change in the message broker cluster's node composition, while managing the migration's impact on the message broker cluster's performance.

During operation, a message brokering cluster receives a regular or continuous stream of messages (e.g., a message stream, an event stream) from one or more producer processes, which execute on a set of network servers.

Simultaneously, the cluster facilitates delivery of the messages to one or more consumer processes, which execute on another set of network servers. The stream of messages is separated into topics, and each topic is typically divided into multiple partitions in order to distribute the topic's messages (and workload) among the nodes in the cluster. Further, each partition may be replicated to provide fault tolerance. Each set of replicas includes a leader replica that handles read and write requests (e.g., the incoming messages) for the partition, and zero or more follower replicas that actively or passively mimic the leader replica.

The message brokering cluster is composed of one or more server nodes called brokers. Each broker may be assigned replicas that are associated with one or more partitions. One of the brokers may be designated a cluster controller and manage the states of partitions and replicas within the message brokering cluster. A centralized detector detects failures among the nodes of the cluster. In some implementations, each of the brokers maintains a heartbeat via a unique network-accessible and broker-specific path, wherein the availability of the path signifies that the broker is operational.

In some instances, responsive to one of the brokers becoming unreachable, the detector or some other entity takes down the broker's associated path. Upon determining that a broker or its path can no longer be accessed, a threshold period of time may be allowed to filter out short periods of routine downtime (e.g., network lag, reboots). If the broker is still unreachable after the threshold period expires, an analyzer (or some other entity) selects or generates a plan that specifies a set of mappings between replicas that need to be migrated from the failed broker and brokers to which the replicas are to be migrated in order to heal the cluster. An executor entity then executes the plan and moves the replicas. Similarly, if a node is to be decommissioned or otherwise gracefully removed from the cluster, the analyzer may design a plan for redistributing the node's replicas.

In some instances, responsive to a new broker being added to the message brokering cluster, the analyzer selects or generates a plan to reassign replicas to the new broker, from existing brokers, to promote balanced distribution of partitions/replicas across the brokers of the cluster.

Further, a central monitor continually or regularly monitors resource usage of members of the message broker cluster (e.g., data input/output (I/O) per partition, CPU utilization, network I/O per partition). Upon recognition of an anomaly or an imbalance in the brokers' resource usages (e.g., resource utilization above a threshold by one or more brokers, a difference in utilization by two brokers that is greater than a threshold), the monitor notifies the analyzer (and may describe the anomaly). To alleviate the undesired condition, the analyzer selects or generates a plan that identifies one or more partition replicas to migrate or reassign between two or more brokers.

Because simultaneously invoking the migration of multiple replicas within the set of mappings of a given plan may degrade the message brokering cluster's performance, the set of mappings may be divided into multiple smaller “chunks,” and only a single chunk of replicas may be migrated at a time. For example, the analyzer may publish one chunk at a time to the executor, or the executor may publish one chunk at a time to a cluster controller. In response, the executor (or controller) reassigns each of the replicas in the chunk between the specified brokers. Afterward, follower replicas replicate data from their respective leader replicas.

However, to avoid degrading the message brokering cluster's performance, the executor may not publish the next chunk until all (or most) of the replicas of the first chunk have caught up to their respective leaders. In some implementations, an entire plan or set of mappings may be passed to the executor by the analyzer, but the executor generally will still allow only one chunk's replicas to be in flight at a time.

In addition to alleviating or relieving an imbalance in brokers' resource utilizations, a plan for partition/replica migration may attempt to satisfy several goals. In some environments, any goals designated as ‘hard’ goals must be accommodated, and plan generation will fail if they cannot be satisfied. This may cause an exception to be thrown if, for example, a broker has failed and no valid plan can be generated for continued operation of the message brokering cluster. A plan will also attempt to satisfy one or more ‘soft’ goals, but failure to meet some or all soft goals will not prevent an otherwise satisfactory plan (e.g., a plan in which all hard goals are satisfied) from being implemented. Plan goals are described in more detail below.

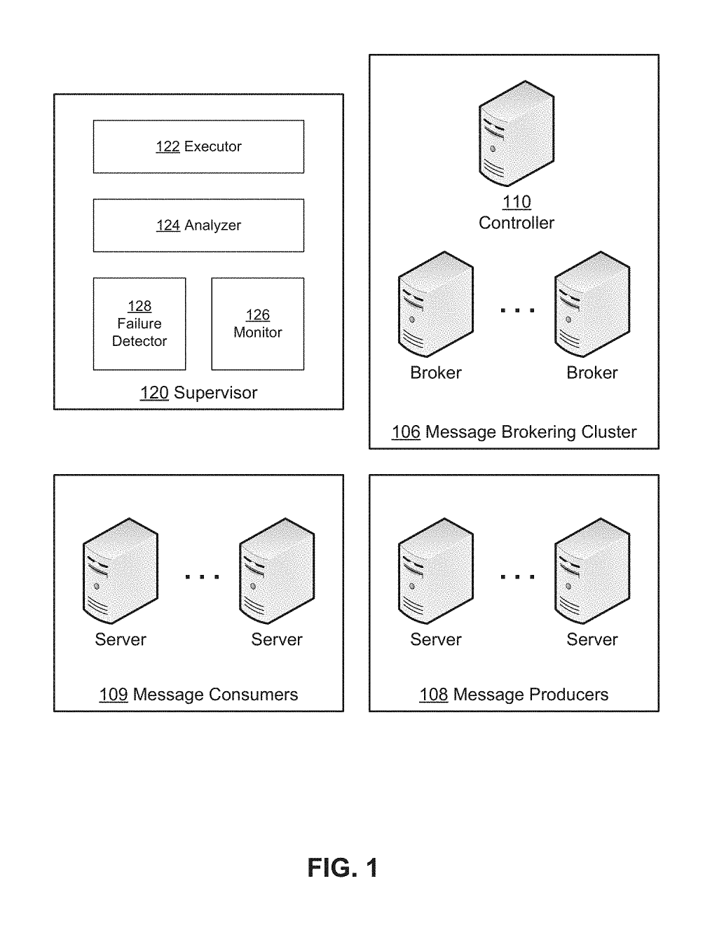

FIG. 1 shows a schematic of a computing environment in accordance with the disclosed embodiments. As shown in FIG. 1, environment 100 encompasses one or more data centers and other entities associated with operation of a software application or service that handles a stream of messages, and includes different components in different embodiments. In the illustrated embodiments, the environment includes supervisor 120, message brokering cluster 106, message producers 108, and message consumers 109.

The data centers may each house one or more machines (i.e., servers, computers) on which one or more instances or components of the software application are executed. The machines may be organized into one or more clusters of machines, such as message brokering cluster 106. In some embodiments, the total number of machines may number in the thousands, with each data center having many clusters and each cluster having many machines.

In general, a cluster of machines may share common properties. For instance, each of the servers in message brokering cluster 106 (i.e., the brokers and controller 110) may execute at least one instance of a message brokering process that cooperates with and/or coordinates with one or more other message brokering processes executing within the cluster.

In some embodiments, message brokering cluster 106 corresponds to a Kafka cluster. Kafka is a distributed, partitioned, and replicated commit log service that is run as a cluster comprised of one or more servers, each of which is called a broker. A Kafka cluster generally maintains feeds of messages in categories that are referred to as topics. Processes that publish messages or events to a Kafka topic are referred to as producers, while processes that subscribe to topics and process the messages associated with the topics are referred to as consumers. In some cases, a topic may have thousands of producers and/or thousands of consumers.

At a high level, producers send messages over the network to the Kafka cluster, which serves them to consumers. Message producers 108 may correspond to a set of servers that each executes one or more processes that produce messages for Kafka topics that are brokered by message brokering cluster 106. A message producer may be responsible for choosing which message to assign to which partition within the Kafka topic. The message producer may choose partitions in a round-robin fashion or in accordance with some semantic partition function (e.g., based on a key derived from the message). When a message is received by the message brokering cluster, one of the cluster's brokers facilitates the delivery of the message to one or more consumers in message consumers 109. Message consumers 109 may correspond to a set of servers that each executes one or more consumer processes that subscribe to one of the Kafka topics brokered by the cluster.

Communication between the producers, consumers, and the Kafka cluster is done with a high-performance, language-agnostic Transmission Control Protocol (TCP) protocol. Messages published to Kafka topics may be written in various formats, including Javascript Object Notation (JSON) and Avro.

For each topic, the Kafka cluster maintains a log of messages that is divided into partitions. Each partition is an ordered, immutable sequence of messages that is continually appended to with new messages received from producers. Each message in a partition is assigned a sequential id number, known as an offset, which uniquely identifies the message within the partition. The Kafka cluster retains published messages for a configurable period of time, regardless of whether they have been consumed. For example, if the Kafka cluster is configured to retain messages for two days, after a message is published, the message is available for consumption for two days, and then the message is discarded to free up space. Dividing a topic into multiple partitions allows the Kafka cluster to divide the task of handling incoming data for a single topic among multiple brokers, wherein each broker handles data and requests for its share of the partitions. On both the producer side and the broker side, writes to different partitions can be done in parallel. Thus, one can achieve higher message throughput by using partitions within a Kafka cluster.

For fault tolerance, each partition is replicated across a configurable number of brokers, wherein copies of the partition are called replicas. Each partition has one replica that acts as the leader (i.e., the leader replica) and zero or more other replicas that act as followers (i.e., follower replicas). The leader replica handles read and write requests for the partition while followers actively or passively replicate the leader. If the leader replica fails, one of the follower replicas will automatically become the new leader replica. Thus, for a topic with a replication factor N, the cluster can incur N−1 broker failures without losing any messages committed to the log. In a Kafka cluster where brokers handle more than one partition, a broker may be assigned a leader replica for some partitions and follower replicas for other partitions in order to increase fault tolerance.

Controller 110 of message brokering cluster 106 corresponds to a broker within message brokering cluster 106 that has been selected to manage the states of partitions and replicas and to perform administrative tasks (e.g., reassigning partitions).

Supervisor 120 supports operation of message brokering cluster 106 by providing for self-healing and balancing of the brokers' workloads. Supervisor 120 may support just cluster 106 or may also support other clusters (not shown in FIG. 1). Supervisor 120 comprises executor 122, analyzer 124, monitor 126, and detector 128, each of which may be a separate service. Supervisor 120 may be a single computer server, or comprise multiple physical or virtual servers.

Detector 128 detects failures among the brokers of message brokering cluster 106 and notifies analyzer 124 and/or other components when a failure is detected. It may also detect addition of a broker to a cluster. In some implementations, detector 128 shares state management information across message brokering cluster 106. In particular, the detector provides or supports a unique path for each broker that maintains a heartbeat monitored by the detector.

For example, the network accessible path “/kafka/brokers/b1” may be provided for a broker “b1,” the path “/kafka/brokers/b2” may be provided for a broker “b2,” and the path “/kafka/brokers/b3” may be provided for a broker “b3.” Each of these paths will be maintained as long as the associated broker periodically sends a heartbeat (e.g., every 30 seconds). During operation of cluster 106, detector 128 (and/or monitor 126) monitors these paths to track which brokers are reachable.

Central monitor 126 monitors brokers' utilization of resources such as CPU, storage (e.g., disk, solid state device), network, and/or memory, generates a model to represent their current workloads, and passes that model to analyzer 124. The monitor may also, or instead, directly report some metrics (e.g., if a model cannot be generated). Thus, the monitor notifies the analyzer (and/or other components) when an anomaly is detected (e.g., resource usage is higher than a threshold, uneven usage between two or more brokers that exceeds a threshold).

Because the message brokering cluster 106 is a dynamic entity, with brokers being added/removed, topics being added, partitions being expanded or re-partitioned, leadership for a given partition changing from one broker to another, and so on, it is possible for some resource utilization information to be unavailable at any given time. To minimize the effect of unavailable resource usage data, and to ensure that any plan that is adopted for execution is sound, one or more safeguards may be implemented. For example, multiple sampling processes may execute (e.g., on the monitor, on individual brokers) to obtain usage measurements of different resources for different partitions hosted by the brokers. Therefore, even if one sampling process is unable to obtain a given measurement, other processes are able to obtain other measurements.

In some implementations, resource usage measurements are aggregated into time windows (e.g., hours, half hours). For each replica of each partition (i.e., either the leader or a follower), for each topic, and for each time window, if an insufficient number of metrics has been obtained (e.g., less than 90% of scheduled readings, less than 80%, less than 50%), the corresponding topic and its partitions are omitted from the model(s) that would use the data collected during that time window.

In addition, when a workload model is generated from a set of resource usage measurements (e.g., including metrics from one or more time windows), the number and/or percentage of the partitions hosted by the cluster that are included in the model is determined. If the model encompasses at least a threshold percentage of the partitions (e.g., 95%, 99%), it is deemed to be a valid model and is passed to the analyzer for any necessary action.

Analyzer 124 generates plans to resolve anomalies, implement self-healing, and/or otherwise improve operation of cluster 106 (e.g., by balancing brokers' workloads). Based on information received from detector 128, a model received from monitor 126, and/or other information provided by other components of the computing environment, a plan is generated to move one or more partitions (or partition replicas) from one broker to another, to promote a follower replica to leader, create a new follower replica, and/or take other action. A plan generally includes a mapping between partitions to be moved or modified in some way (e.g., to promote a follower replica) and the broker or brokers involved in the action. The analyzer may generate a plan dynamically, based on a reported anomaly or broker failure, and/or may store plans for implementation under certain circumstances. The analyzer may consider any number of possible changes to the current distribution of replicas within the cluster, estimate the effect of each, and include in a plan any number of changes that, together, are likely to improve the state of the cluster.

Executor 122 receives a plan from analyzer 124 and executes it as described further below. In some implementations, executor 122 executes the plan. In other implementations, executor 122 and controller 110 work together to implement a plan. In yet other implementations, executor 122 (or analyzer 124) may pass the plan to controller 110 for execution.

When generating a plan for healing or for balancing the workload within a message brokering cluster, goals of analyzer 124 may include some or all of the following (and/or other goals not identified here). One illustrative ‘hard’ goal requires the leader replica of a partition and follower replicas of that leader to reside on different racks (computer racks, server racks). Multiple brokers may be located in a single rack. A second illustrative hard goal limits the resource utilization of a broker. For example, a broker normally may not be allowed to expend more than X % of its capacity of a specified resource on processing message traffic (CPU, volatile storage (memory), nonvolatile storage (disk, solid-state device), incoming or outgoing network traffic). The specified threshold may be per-replica/partition or across all replicas/partitions on the broker, and different thresholds may be set for different resources and for different brokers (e.g., a controller broker may have lower thresholds due to its other responsibilities).

Some illustrative ‘soft’ goals for a broker include (1) a maximum allowed resource usage of the broker (e.g., as a percentage of its capacity) that it may exhibit if some or all of its replicas are or were to become leaders (e.g., because other brokers fail), (2) even distribution of partitions of a single topic across brokers in the same cluster, (3) even usage (e.g., as percentages of capacity) of nonvolatile storage across brokers in the same cluster, (4) even levels of other resource usage (e.g., CPU, inbound/outbound network communication) across brokers in the same cluster, and (5) even distribution of partitions (e.g., in terms of numbers or their resource utilization) across brokers in the same cluster.

Other illustrative goals may seek: balanced resource usage across racks, even distribution of partitions of a given topic among racks that include brokers participating in a single cluster, and/or even distribution of partitions (regardless of topic) among racks. A goal that is ‘soft’ in one embodiment or computing environment may be ‘hard’ in another, and vice versa.

In order to track the resource usage of brokers in message brokering cluster 106, they may regularly report usage statistics directly to monitor 126 or to some other entity (e.g., controller 110) from which the monitor can access or obtain them. The monitor may therefore be configured to know the hard and soft goals of each broker, and will notify analyzer 123 when an anomaly is noted.

Because the actual usage or consumption of different resources is actively tracked on a per-replica/partition basis and/or a per-broker basis, when the analyzer must generate a plan to heal the message brokering cluster or to balance its workload, it can determine the resource demands that would be experienced by a broker if it were to be assigned additional replicas, if one or more of its follower replicas were promoted, or if some other modification was made to its roster of partition replicas. In particular, the added resource usage experienced when a particular change is implemented (e.g., movement of a follower replica) from one broker to another may be noted. Later, if further movement of that follower replica may be considered for inclusion in a plan, the likely impact will already be known. Also, or instead, resource usage that is reported on a per-replica basis provides a direct indication of the impact of a particular replica.

In some embodiments, message brokering cluster 106 and some or all components of supervisor 120 comprise a system for performing self-healing and/or workload balancing among message brokers.

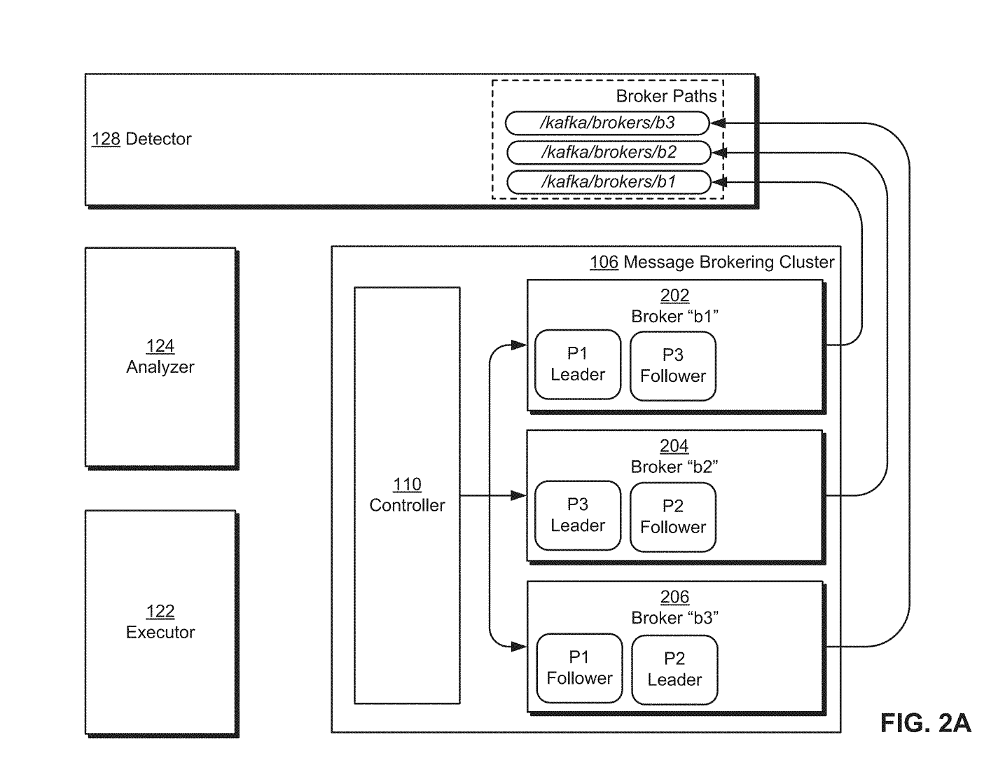

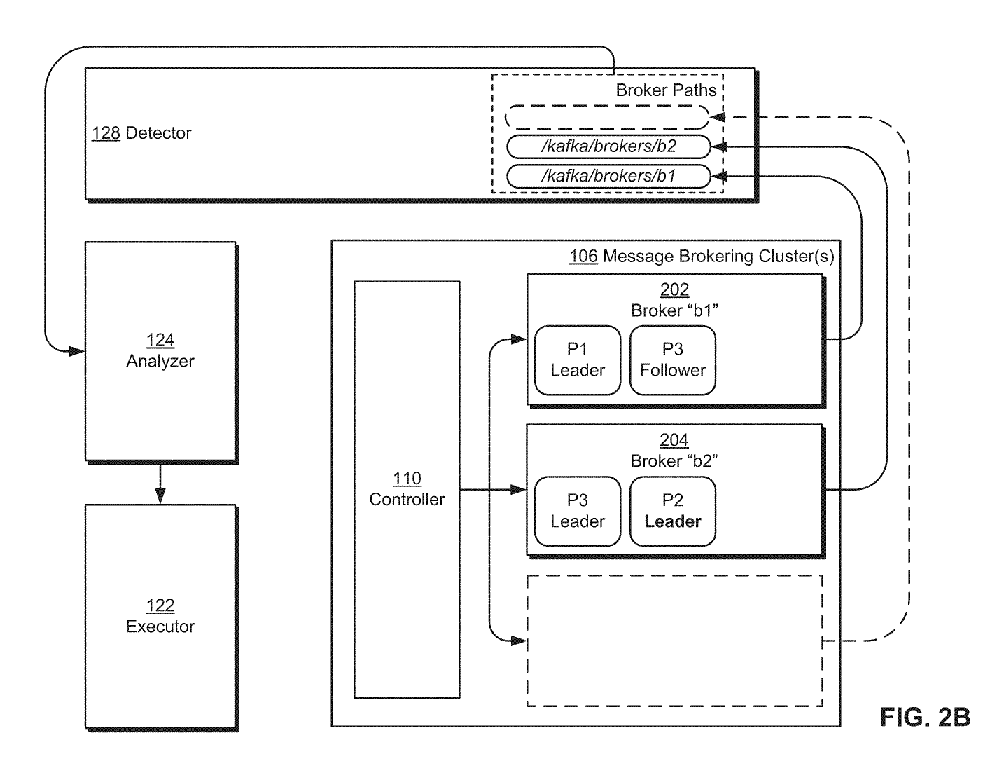

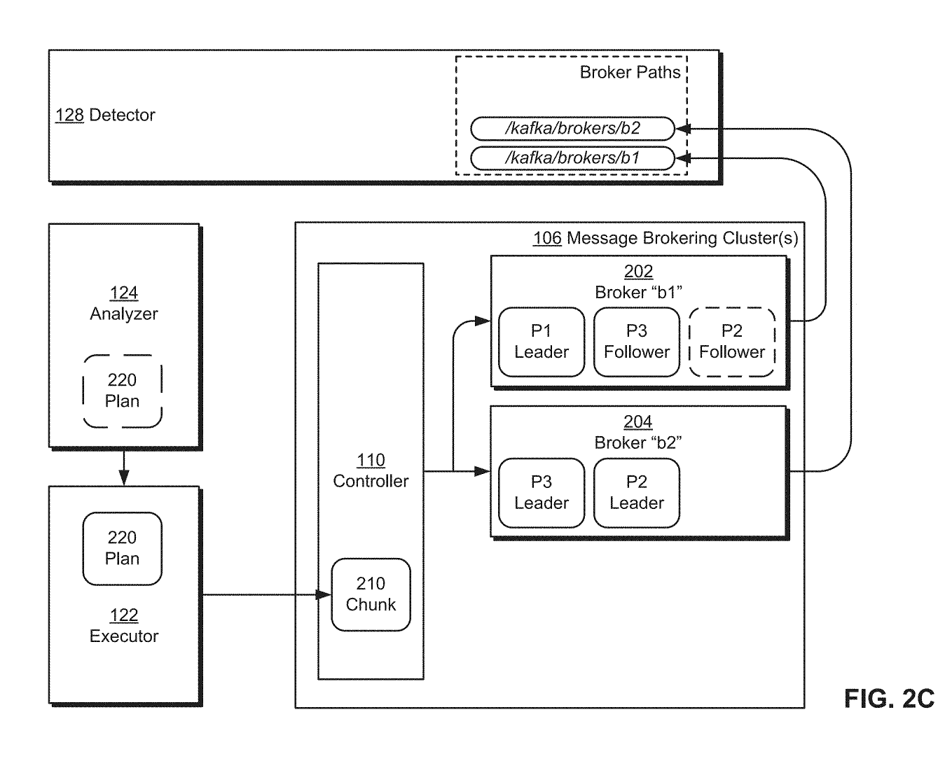

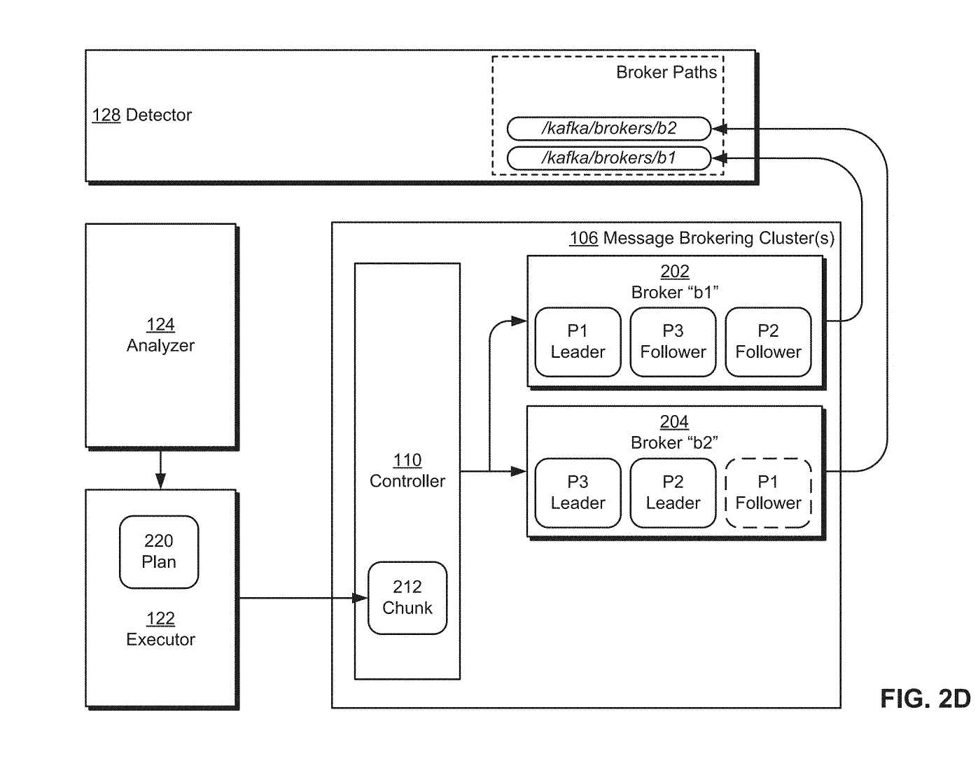

FIGS. 2A-2D show a system that enables self-healing across nodes within a message broker cluster in accordance with the disclosed embodiments. More specifically, FIGS. 2A-2D illustrate a series of interactions among detector 128, analyzer 124, executor 122, and message brokering cluster 106 that automate healing of the cluster in response to the loss of a broker.

FIG. 2A shows the system prior to the series of interactions. At this point, message brokering cluster 106 includes controller 110; broker 202, which has the identifier “b1;” broker 204, which has the identifier “b2;” and broker 206, which has the identifier “b3.” A topic handled by the message brokering cluster is divided into three partitions: P1, P2, and P3. The topic has a replication factor of two, which means each partition has one leader replica on one broker and one follower replica on a different broker. As a result, message brokering cluster 106 can tolerate one broker failure without losing any messages. Broker 202 is assigned the leader replica for partition P1 and a follower replica for partition P3. Broker 204 is assigned the leader replica for partition P3 and a follower replica for partition P2. Broker 206 is assigned a follower replica for partition P1 and a leader replica for partition P2. As shown in FIG. 2A, each of brokers 202, 204, and 206 maintains a heartbeat to the failure detection service, which is made apparent in the three paths “/kafka/brokers/b1”, “/kafka/brokers/b2”, and “/kafka/brokers/b3”. While the illustrated embodiments do not portray controller 110 as being assigned any replicas, it should be noted that in some embodiments, controller 110 may also be assigned its own share of replicas.

FIG. 2B shows the system after broker 206 becomes unreachable across the network. Because broker 206 is no longer able to maintain its heartbeat, the detector takes down its associated path “/kafka/brokers/b3”. Detector 128 learns of or is informed of broker 206's unavailability via periodic polling of the brokers' paths or through a call-back function invoked upon removal of broker 206's path. In response, metadata concerning broker 206's unavailability may be written at a path such as “/clusters/failed-nodes”, and/or the detector may notify analyzer 124. The metadata may include the unavailable broker's identifier (e.g., b3) and a timestamp of the failure.

As shown in FIG. 2B, the follower replica for partition P2 that is assigned to broker 204 takes over for the now-unavailable leader replica for partition P2 that was on broker 206. This may be implemented automatically by controller 110 as part of its duty of ensuring a leader replica exists for each partition, or may be implemented as part of a plan identified by analyzer 124 and initiated by executor 122. Assuming that the follower replica for partition P2 was in sync with the leader replica for partition P2 at the start of broker 206's unavailability, the follower replica has enough data to replace the leader replica without interrupting the flow of the partition P2. In some embodiments, the transition of a (synchronized) follower replica to a leader replica takes only a few milliseconds.

It should be noted that brokers may become unavailable for various reasons, and it may not always be worthwhile to assign a new follower replica to support a new leader replica (e.g., a replica that transitioned to leader from follower) or to replace a failed follower replica. In particular, it may take a long time to synchronize a new follower replica with the leader replica, which involves copying enough data from the leader replica so that the follower can take over if the leader replica's broker fails. Thus, if broker 206 becomes unreachable due to a failure that takes an inordinate time to diagnose and/or fix (e.g., a hardware failure), assigning or reassigning follower replicas to remaining brokers may be worthwhile.

On the other hand, if broker 206 becomes unreachable due to a reboot (e.g., after installing a software update) or some other short-term event or condition that resolves relatively quickly, reassigning replicas may not be worthwhile, and the assignment or reassignment of follower replicas could cause side effects that degrade the cluster's throughput. Therefore, a threshold period of time (e.g., 30 minutes) may be permitted to pass before invoking the assignment or reassignment of one or more follower replicas.

If broker 206 becomes reachable within the threshold period of time, its heartbeat will cause detector 128 to reinstate its associated path “/kafka/brokers/b3” and metadata concerning broker 206's unavailability may be purged. If broker 206 is unreachable for longer than the threshold period of time, reassignment of one or more replicas hosted by broker 206 will be initiated (e.g., in accordance with a plan established by analyzer 124 and executed by executor 122 and/or controller 110).

FIG. 2C shows the system after broker 206 has been unreachable for longer than the threshold period. At this point, analyzer 124 uses decision making logic (not depicted in FIG. 2C) to determine where to reassign broker 206's replicas and assembles plan 220 for executing the reassignment, or retrieves a stored plan that accommodates the situation. To promote fault tolerance, and in order to satisfy workload balancing goals, the analyzer may attempt to (or be required to) reassign replicas so that all replicas for the same partition are not found on the same broker. Plan 220 is forwarded to executor 122 for implementation.

It should be noted that in situations where the unreachable broker was assigned a large number of replicas (e.g., 100 replicas in a cluster larger than that depicted in FIGS. 2A-2D), migrating most or all of the replicas simultaneously could degrade the message brokering cluster's performance (especially if the reassigned replicas have to catch up on a long period of message traffic). To avoid this detrimental effect, once the set of reassignments has been determined (i.e., mappings between replicas to be migrated and brokers to which the replicas are to be migrated), the set of reassignments is divided into multiple smaller chunks of reassignments (e.g., to continue the example involving 100 replicas, 20 chunks may be identified that each specify how to reassign five replicas). In some embodiments, the chunk size is a configurable setting. Illustratively, division of the necessary replica reassignments into chunks may be part of the plan created or selected by analyzer 124, or may be implemented separately by executor 122.

Next, executor 122 writes the set of assignments to controller 110 one chunk at a time (e.g., chunk 210), wherein the assignments of a particular chunk are not published until all (or some) replicas specified by the assignments of the previous chunk have finished migrating (i.e., are in sync with their respective leader replicas). By “chunking” the migration process in this fashion, some embodiments may reduce the amount of data transfer and other side effects present within the message brokering cluster and, as a result, preserve the cluster's performance and throughput. In some embodiments, each chunk contains one or more (re)assignments of replicas formatted in JSON.

With respect to FIGS. 2A-2D, the set of reassignments includes a total of two replicas and the chunk size is configured to be one reassignment: the follower replica for partition P1 and the follower replica (formerly leader replica) for partition P2. After determining the set of two reassignments, the executor divides the set into two chunks of one reassignment each: chunks 210 (shown in FIG. 2C) and 212 (shown in FIG. 2D).

Next, the executor writes chunk 210 to controller 110 and/or to some other location that can be accessed by controller 110. After chunk 210 is published, controller 110 reads the contents of the chunk and applies the one or more reassignments requested by the chunk. As shown in FIG. 2C, after reading the contents of chunk 210, controller 110 reassigns the follower replica for partition P2 from former broker 206 to broker 202, wherein the replica begins to replicate data from the leader replica for partition P2 at broker 204. Executor 122 does not write another chunk until the follower replica for partition P2 becomes in sync with (i.e., catches up to) the leader replica for partition P2.

FIG. 2D shows the system after the replica reassignment specified by chunk 210 has been completed. At this point, chunk 212 is written to controller 110 or to a location that can be accessed by controller 110. After reading the contents of chunk 212, controller 110 reassigns the follower replica of partition P1 from former broker 206 to broker 204, at which point the replica begins to replicate data from the leader replica for partition P1 at broker 202.

In some embodiments, the process of migrating a set of replicas in response to the unavailability of a broker is short-circuited if the broker returns to service after a relatively brief period of time. Short-circuiting the migration process when a recently departed broker reappears may be advantageous because (1) the replicas originally or previously assigned to the returned broker are generally only slightly behind their respective leader replicas (e.g., if a broker was unavailable for an hour, the replicas would be one hour behind their leader replicas); and (2) newly assigned replicas could be much farther behind their respective leader replicas (e.g., if a leader replica contains a week's worth of data, a reassigned follower replica would need to replicate the entire week of data). Thus, to reduce the amount of data that needs to be replicated, the analyzer or executor may (1) halt the application of chunks and (2) cause the controller to return to the recovered broker the replicas that were reassigned in response to the broker's unavailability. In some embodiments, the message brokering cluster may reinstate the replicas at the returned broker and delete the reassigned replicas.

For example, if a broker that contains 100 replicas, each of which contains two weeks' worth of data, suddenly goes offline, the set of 100 reassignments may be divided into, say, 20 chunks. The executor would begin writing the chunks (for use by controller 110) one by one, wherein a chunk is not written before the replicas specified by the previous chunk have fully caught up. If the offline broker comes back online after five hours, at which point perhaps chunk 4 out of 20 is being migrated, the executor (or some other system component) may halt the migration of chunk 4, cancel the migration of chunks 5 through 20, and undo the migrations of chunks 1 through 3 and the partial migration of chunk 4.

However, when a previously unavailable broker returns to service, if the newly assigned replicas are closer to the leader replicas than their original replicas in terms of completeness, the migration process may continue even after the broker is returned to service. In some implementations, migration may proceed if the amount of data residing in the newly assigned replicas at the time of the broker's return is equal to or greater than some percentage of the amount of data in the original replicas (e.g., 50%).

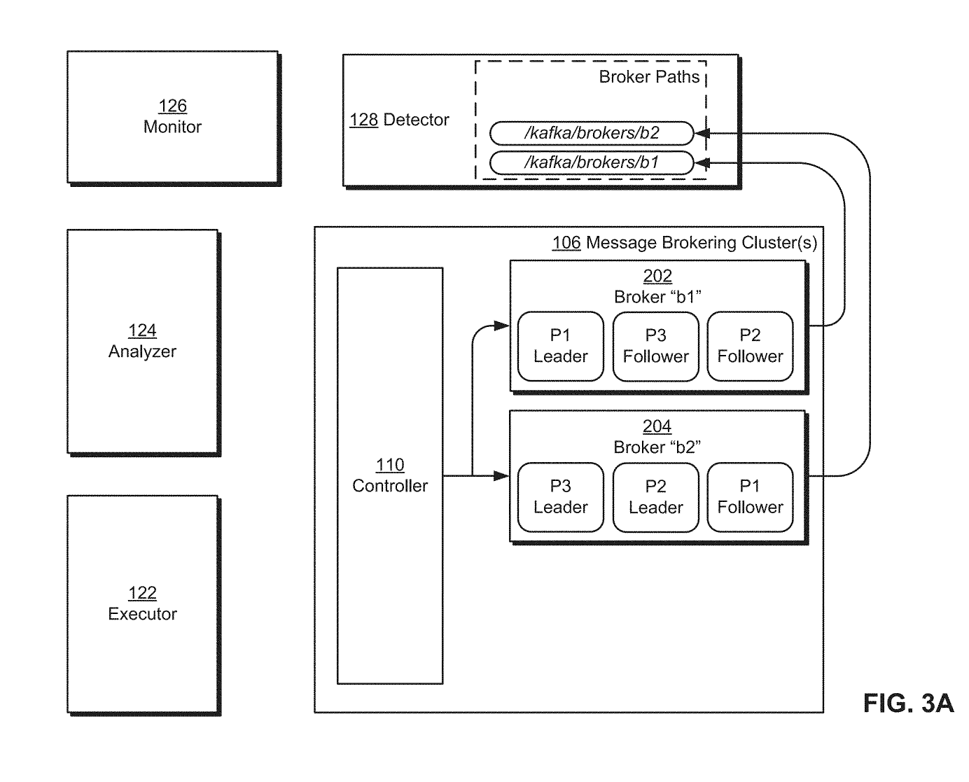

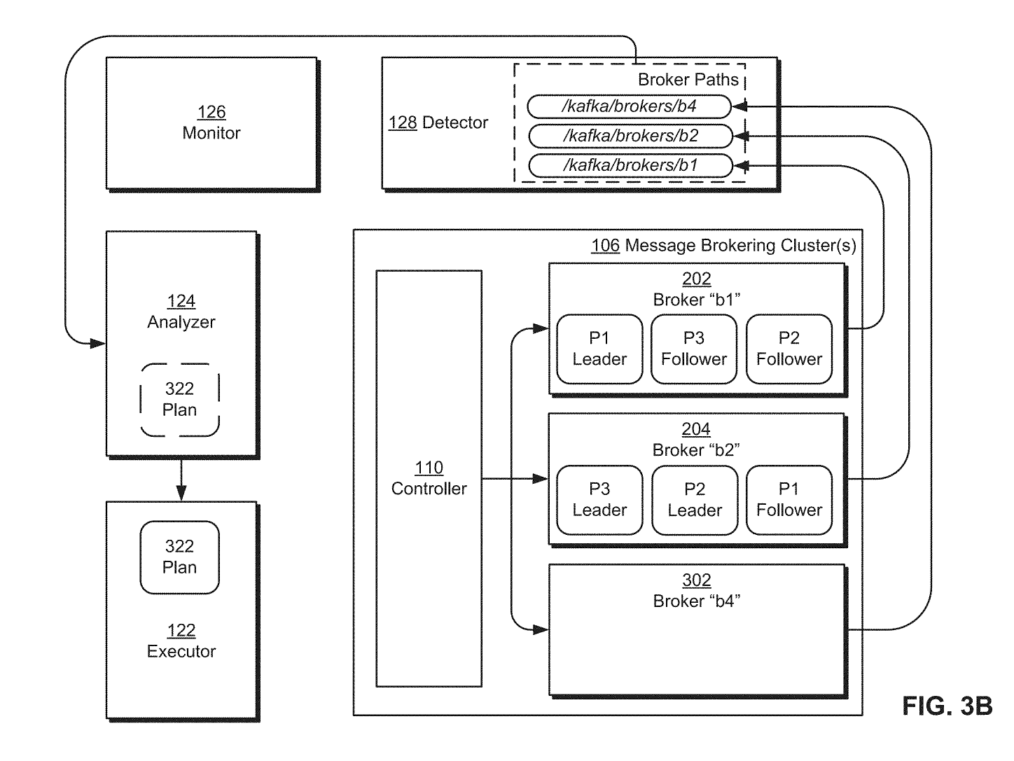

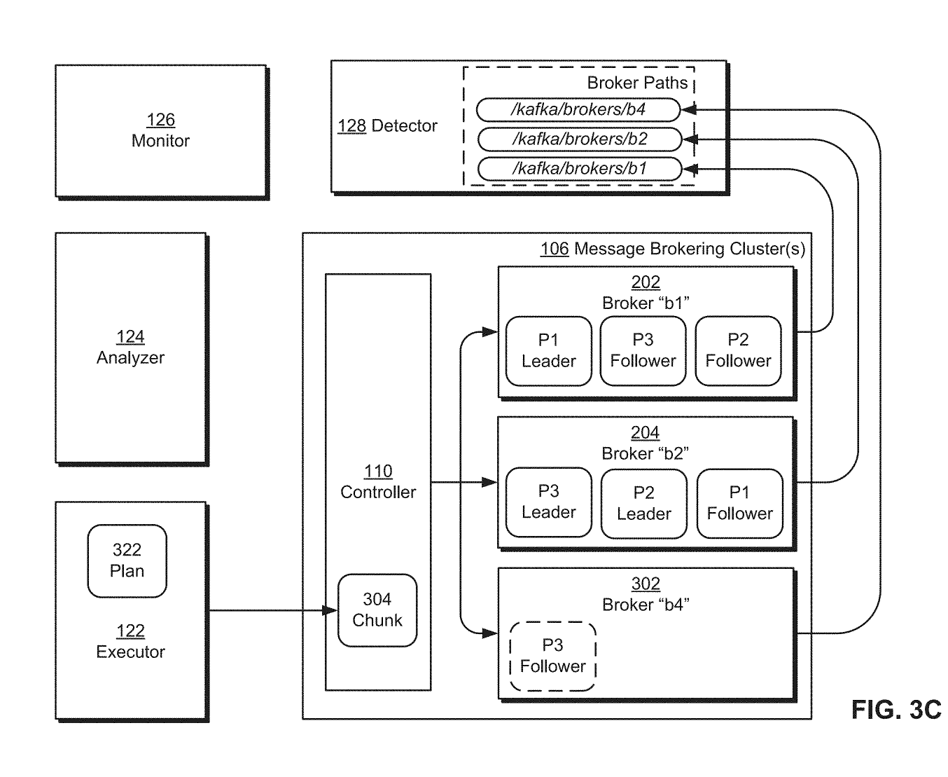

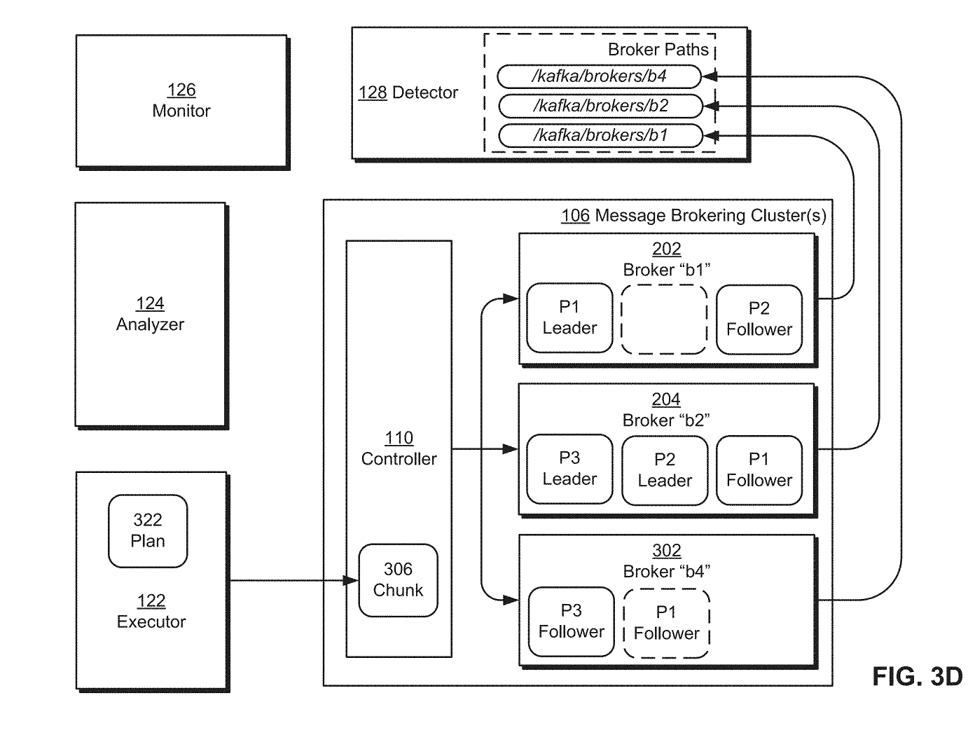

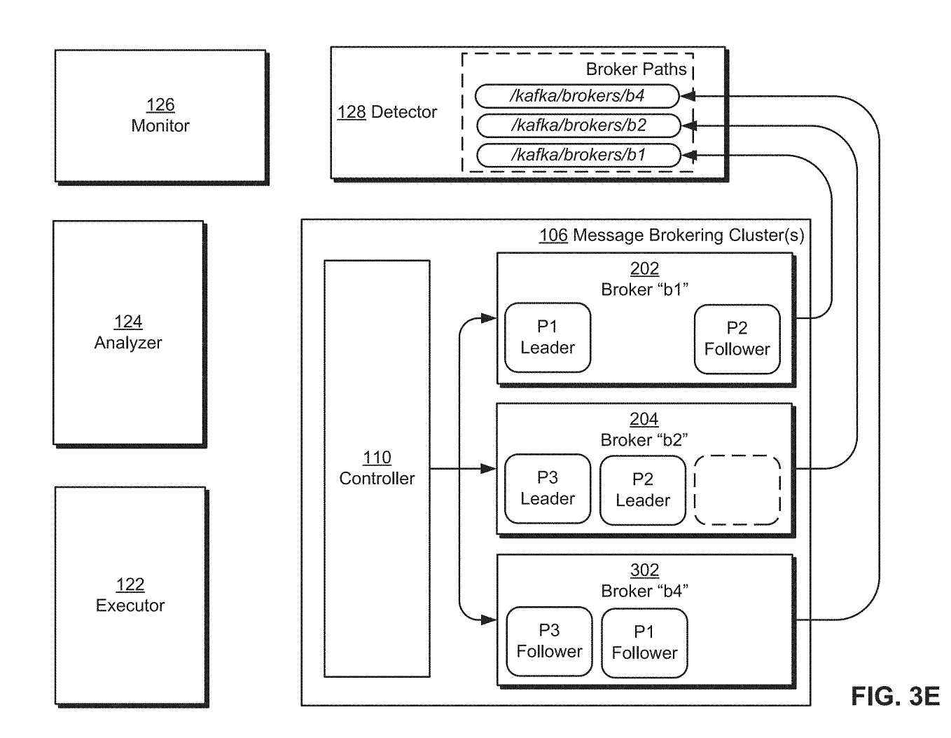

FIGS. 3A-3E show a system that balances partition distribution across nodes within a message broker cluster in accordance with the disclosed embodiments. More specifically, FIGS. 3A-3E illustrate a series of interactions among detector 128, monitor 126, analyzer 124, executor 122, and message brokering cluster 106 that balance the message storage and processing workload across members of the cluster. The figures depict action that occurs after addition of a new broker to the message brokering cluster. As described above and below, the cluster's workload may also, or instead, be balanced when an anomaly is detected (such as uneven or excessive resource utilization), and may also be balanced upon demand (e.g., when triggered by a system operator).

FIG. 3A shows the system prior to the series of interactions. At this point, message brokering cluster 106 includes controller 110; broker 202, which has the identifier “b1;” and broker 204, which has the identifier “b2.” A topic handled by the message brokering cluster is divided into three partitions: P1, P2, and P3. The topic has a replication factor of two. Broker 202 is assigned the leader replica for partition P1, a follower replica for partition P3, and a follower replica for partition P2. Broker 204 is assigned the leader replica for partition P3, the leader replica for partition P2, and a follower replica for partition P1. As shown in FIG. 3A, each of brokers 202 and 204 maintains a heartbeat monitored by detector 128, which is made apparent in the two paths “/kafka/brokers/b1” and “/kafka/brokers/b2”.

FIG. 3B shows the system after broker 302, which has the identifier “b4,” is added to message brokering cluster 106. The new broker begins sending heartbeats to detector 128, which creates a path “/kafka/brokers/b4” that is associated with broker 302. Detector 128 may learn of or be informed of broker 302's introduction via periodic polling of the brokers' paths or through a call-back function that is invoked in response to the addition of broker 302's path. The analyzer may learn of the new broker node from detector 128 and/or monitor 126 (e.g., when the monitor receives a report of resources used by broker 302) or may be directed by a system operator to generate a new workload distribution plan that includes the new broker.

As shown in FIG. 3B, partition distribution among the three brokers is imbalanced because each of brokers 202, 204 is assigned three replicas while broker 302 is assigned none. While broker 302 could be prioritized to receive new replica assignments in the message stream when new partitions and/or topics are introduced to the cluster, the load imbalance may persist for some time unless an active rebalancing step is taken. Thus, to balance partition distribution and workload among the three brokers, analyzer 124 generates or selects plan 322, which attempts to distribute the workload more evenly by reassigning one or more replicas to broker 302.

Generation of the plan may involve consideration of different factors and criteria in different embodiments. The hard and soft goals described above are some of these factors. The analyzer may also consider per-partition/replica and/or per-broker resource utilization, as collected and reported by monitor 126. For example, the analyzer may be informed (by a model provided by monitor 126) of (1) the volume of incoming data being received by each broker (e.g., for each broker, the volume of incoming data associated with partitions/replicas assigned to the broker, in bytes per second), (2) the volume of incoming data associated with each replica (e.g., for each broker, the volume of incoming data associated with each partition/replica assigned to the broker), (3) the storage status of each of the brokers (e.g., the percentage of storage space still free (or occupied) in each broker, possibly on a per-replica basis), and/or (4) the level of CPU utilization of each broker (e.g., the percentage of CPU cycles required to handle the broker's message traffic, possibly on a per-replica basis.

FIG. 3C shows the system during the reassignment of one or more replicas to broker 302 in accordance with plan 322. In particular, the follower replica for partition P3 is reassigned from broker 202 to broker 302.

As described above in conjunction with a self-healing operation, to avoid degrading the cluster's performance, once the set of replica reassignments has been determined (e.g., 100 replicas), executor 122 or some other component of the system (e.g., analyzer 124, controller 110) may divide the set into multiple smaller chunks of reassignments (e.g., 20 chunks that each specify reassignment of five replicas). Next, the executor identifies the set of assignments to controller 110 one chunk at a time, wherein the assignments of a particular chunk are not published until the replicas specified by the assignments of the previous chunk have finished migrating (i.e., are in sync with their respective leader replicas).

With respect to FIGS. 3A-3E, the set of reassignments includes a total of two replicas (the follower replica for partition P3 and the follower replica for partition P1) and the chunk size is configured to be one reassignment. After determining the set of two reassignments, the executor divides the set into two chunks of one reassignment each: chunk 304 (shown in FIG. 3C) and chunk 306 (shown in FIG. 3D). Next, the executor writes chunk 304 to controller 110 or to a particular path that can be accessed by controller 110. Once a chunk is published, the contents of the chunk are read and the one or more reassignments specified by the chunk are applied to the cluster. As shown in FIG. 3C, after reading the content of chunk 304, controller 110 reassigns the follower replica for partition P3 from broker 202 to broker 302, wherein the replica begins to replicate data from the leader replica for partition P3 at broker 204. Executor 122 does not write another chunk until the follower replica for partition P3 becomes in sync with the leader replica for partition P3. In some embodiments, once the follower replica for partition P3 on broker 302 is in sync with the leader replica for partition P3, the former follower replica for partition P3 on broker 202 is removed; alternatively, it may be maintained as an additional follower replica for a period of time or may remain as it is with broker 202 (i.e., without replicating the leader replica for P3, but without deleting its contents).

FIG. 3D shows the system after the replica specified by chunk 304 has caught up. At this point, executor 122 writes chunk 306 to/for controller 110. After reading the content of chunk 306, controller 110 reassigns the follower replica of partition P1 from broker 204 to broker 302, at which point the replica begins to replicate data from the leader for partition P1 at broker 202.

FIG. 3E shows the system after the replica specified by chunk 306 has caught up to its leader. At this point, no chunks are left and the entire set of reassignments has been applied.

It may be noted that a leader replica for a given partition could be assigned to a new broker (e.g., broker 302 of FIGS. 3A-3E) by, for example, first assigning to the new broker a follower replica of the given partition and then, after the follower replica is in sync with the leader, transitioning the follower to leader. After this, either the former leader replica or a/the follower replica on a different broker could take the role of follower replica.

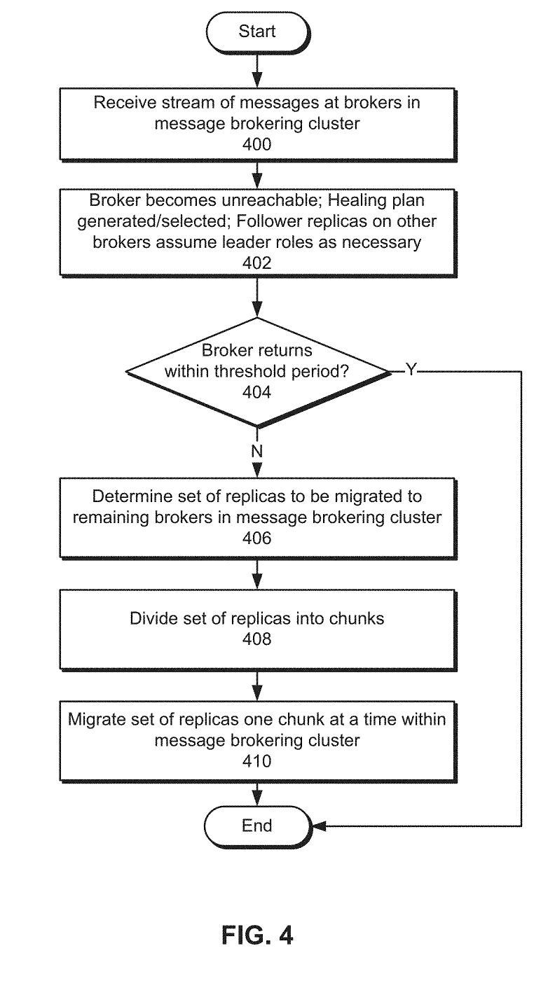

FIG. 4 shows a flowchart illustrating an exemplary process of self-healing of a message broker cluster in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a stream of messages is received at one or more brokers within a message brokering cluster (operation 400). When a broker becomes unreachable (operation 402), follower replicas of leader replicas on the unreachable broker (if any) assume leader roles and the amount of time the broker stays unreachable is tracked.

In some implementations, a detector component/service of a supervisor associated with the cluster identifies the broker failure (as described above) and notifies an analyzer component/service of the supervisor. The analyzer develops a plan for healing the cluster, or retrieves a suitable preexisting plan, and passes it to an executor component/service. The executor may immediately execute a portion of the plan that causes the selected follower replicas to become leaders. In some embodiments, however, the executor or a controller within the cluster promotes the follower replicas even before a plan is put into action (in which case follower-to-leader promotions may be omitted from the plan). Therefore, after operation 402, the cluster is operational but may lack one or more follower replicas.

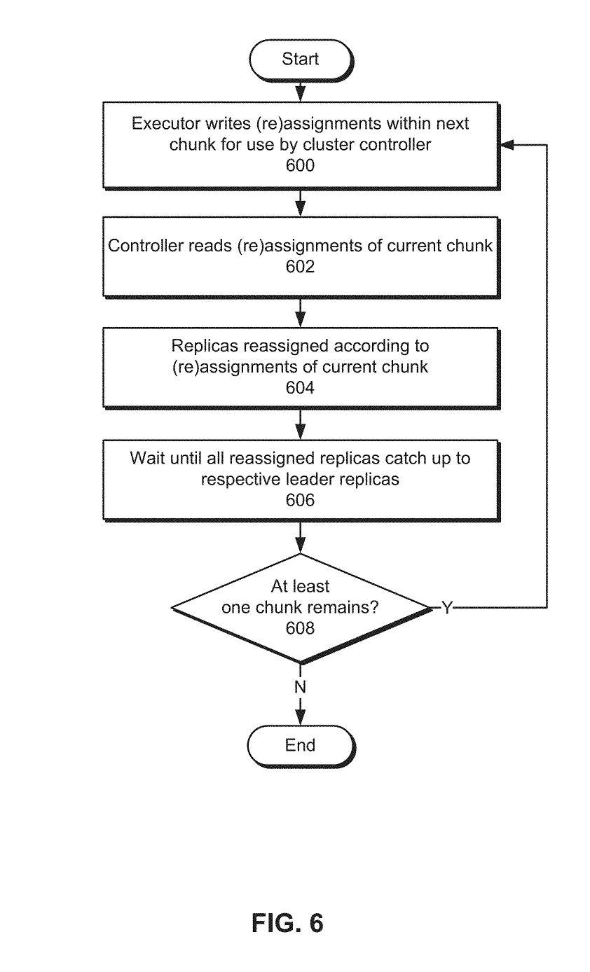

If the broker does not return within a threshold period of time (decision 404), additional steps are taken to heal the message brokering cluster. In particular, a part of the healing plan may now be activated that specifies a set of follower replicas residing on the unreachable broker, and/or follower replicas on other brokers that transitioned to leader roles, to be migrated to the one or more remaining operational brokers within the message brokering cluster (operation 406). Next, the set of replicas is divided into multiple smaller chunks (operation 408). The set of replicas is then migrated within the message brokering cluster one chunk at a time (operation 410). The step of migrating the set of replicas one chunk at a time is discussed in further detail below with respect to FIG. 6.

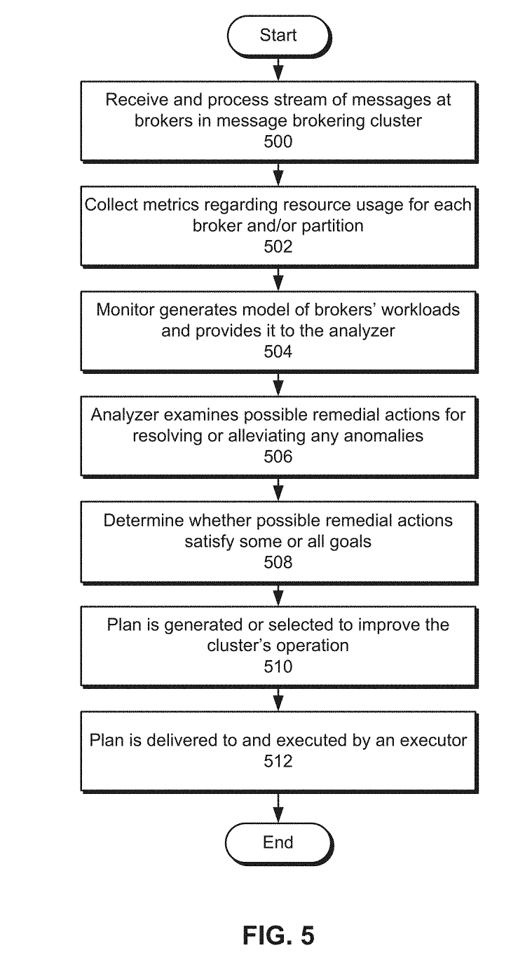

FIG. 5 shows a flowchart illustrating an exemplary process of balancing the workload within a message broker cluster in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

The method of FIG. 5 is applied within a system that includes a messaging broker cluster (comprising multiple message brokers) and a supervisor, such as supervisor 120 of FIG. 1 that includes some or all of: an executor for executing a plan for balancing the cluster's workload and/or healing the cluster after failure of a broker, an analyzer for developing or selecting the plan, a monitor for monitoring or modeling resource utilization by the brokers, and a detector for detecting failure of a broker.

Initially, a stream of messages is received at one or more brokers within the message brokering cluster, the messages are processed, stored, and then made available to consumers (operation 500). The messages belong to one or more topics, and each topic is divided into multiple partitions. Each partition has at least one replica; if there are more than one, one is the leader and the others are followers.

During operation of the brokers, metrics reflecting their use or consumption of one or more resources (e.g., CPU, memory, storage, network bandwidth) are collected (operation 502). Illustratively, these metrics may be collected by sampling processes that execute on the brokers to measure their resource usage at intervals and report them to a central monitor (or some other system component).

Using the collected metrics, the monitor generates a model of the brokers' current workloads and forwards it to the analyzer (operation 504). For example, the model may reflect the average or median level of usage of each resource during a collection of measurements within a given window of time (e.g., one hour), for each partition and/or each broker. Thus, the model will reflect anomalies (e.g., a significant imbalance among the brokers' workloads) that the analyzer should attempt to relieve or alleviate. Generally, a workload imbalance that is other than minimal may cause the analyzer to generate a plan to address the imbalance. Alternatively, a system operator may manually trigger creation (or execution) of a plan to rebalance the brokers' loads or the detector may detect a situation that requires rebalancing (e.g., the addition or removal of a broker).

A model delivered to the analyzer may identify just the resource(s) that are unbalanced, the affected brokers, and their levels of usage, or may provide current usage data for some or all resources for some or all brokers. The average usages may also be provided, and the usage data may be on a per-broker and/or per-replica basis. Thus, the monitor provides the analyzer with sufficient detail to identify an anomaly or anomalies, determine their extent, and assist in the generation of a response plan. Also, detailed information may be provided for some or all replicas (e.g., disk consumption, related network I/O) so that the analyzer will be able to determine the impact on the brokers if a particular replica is moved from one broker to another, if a follower replica is promoted to leader, etc.

Based on an anomaly identified in the model, and any other data provided by the monitor, the analyzer will generate a plan that will likely improve the condition or status of the cluster. In particular, a plan will only be put forward for execution if it is determined (by the analyzer) that it will result in a more balanced workload.

First, however, in the illustrated embodiment the analyzer will investigate the impact of possible changes to the brokers' workloads before selecting one or more that are estimated to improve the workload balance within the cluster and alleviate the uneven resource consumption (operation 506).

For example, the analyzer may investigate the impact of moving one or more replicas from a first broker that is experiencing relatively high resource usage to a second broker experiencing relatively low resource usage. If that might result in simply shifting the overload to the second broker, the analyzer may consider exchanging a busy replica on the first broker (i.e., a replica accounting for more resource consumption than another replica) for a less busy replica on another broker, or may estimate the impact of demoting a leader replica on the first broker (in which case a follower of that replica on another broker must be promoted).

The analyzer also determines whether potential remedial actions will satisfy the hard goals and how many soft goals they will satisfy, and/or whether some other actions may also do so while also satisfying more soft goals (operation 508). Soft goals may be prioritized so that the analyzer can determine when one plan is better than another. In some implementations, all hard goals must be satisfied or no plan will be generated, but one plan (or potential plan) may satisfy more soft goals (or higher priority soft goals) than another.

Thus, from multiple possible plans (each one comprising a different sequence or mix of actions), one plan is generated or selected (operation 510) that will likely improve the cluster's operation (e.g., by balancing the consumption of resources, by balancing the brokers' workloads) and that does not violate any hard goals.

The plan is forwarded to the plan executor, which will implement the specified actions by itself and/or with assistance from other entities (e.g., the cluster's controller node if it has one) (operation 512).

If the plan requires multiple replicas to be reassigned between brokers, the reassignments may be divided into multiple chunks for execution, and only one chunk's worth of replicas may be in flight at a time. Migration of replicas one chunk at a time is discussed in further detail with respect to FIG. 6.

FIG. 6 shows a flowchart illustrating an exemplary process of migrating a set of replicas one chunk at a time within a message broker cluster in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

After the executor or analyzer of the cluster supervisor, or some other entity (e.g., the cluster controller) divides the set of replica reassignments into multiple smaller chunks, the executor (or other entity) writes the (re)assignments specified by the first chunk to a particular network-accessible path (operation 600). A controller of the message brokering cluster then reads the (re)assignments of the first chunk (operation 602) and invokes the reassignment of the replicas within the message brokering cluster as specified by the first chunk (604). Next, the executor waits until replicas that were reassigned in accordance with the first chunk have caught up to their respective leaders (operation 606). The next chunk will not be migrated until after the replicas of the first chunk have finished migrating. So long as another chunk is left in the set of reassignments (decision 608), the process repeats the aforementioned steps.

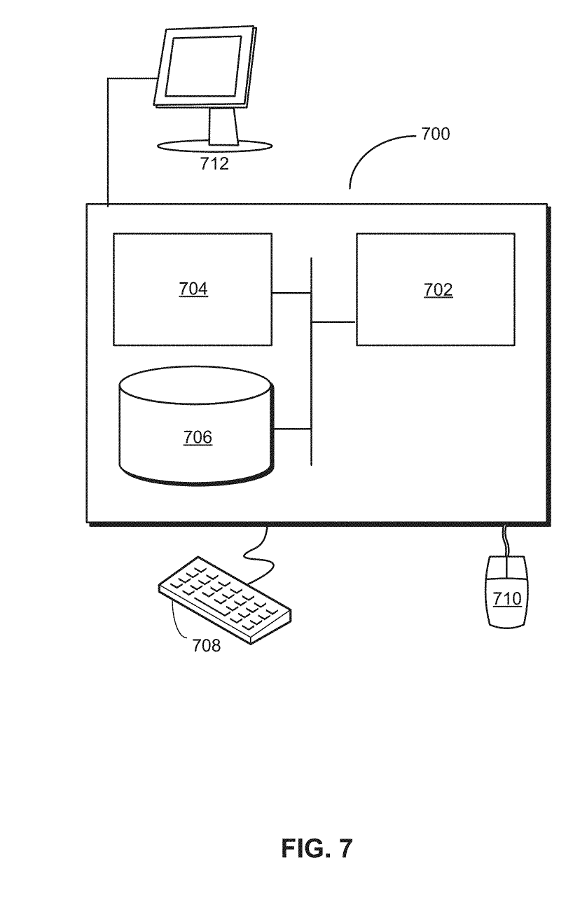

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 includes functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 facilitates self-healing and/or workload balancing across nodes within a message broker cluster. The system may include a message brokering module and/or apparatus that receives a stream of messages at a message brokering cluster, wherein the message stream is divided into partitions and replicas for each partition are distributed among a set of nodes within the message brokering cluster.

The system may also include a detector for detecting failure of a broker, a monitor for monitoring the brokers' resource utilization, an analyzer for generating (or selecting) a plan for improving the cluster's operation (e.g., by healing it after a broker failure, by balancing an uneven workload or consumption of resources), and an executor for initiating execution of the plan. The impact of migration or reassignment of multiple replicas on the cluster may be mitigated by reducing its scope. In particular, the reassignment(s) may be broken into multiple smaller chunks (each chunk including at least one reassignment), and only one chunk's reassignments are allowed to be in flight at any time.

In addition, one or more components of computer system 700 may be remotely located and connected to the other components over a network. Portions of the present embodiments (e.g., application apparatus, controller apparatus, data processing apparatus, etc.) may also be located on different nodes of a distributed system that implements the embodiments. For example, the present embodiments may be implemented using a cloud computing system that manages the profiling of one or a plurality of machines that execute one or more instances of a software application.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
processing a stream of messages at a message brokering cluster, wherein:
the message stream is divided into topics;
each topic is divided into multiple partitions; and
replicas of each partition are distributed among a set of nodes within the message brokering cluster;
monitoring the nodes' usage of a set of resources;
detecting an imbalance in the nodes' usage of the set of resources;
for each of one or more potential adjustments to the distribution of replicas among the nodes:
estimating whether the potential adjustment will alleviate the imbalance; and
determining whether the potential adjustment would violate one or more hard goals for the message brokering cluster; and
executing a plan to adjust the distribution of replicas among the node.

2. The method of claim 1, further comprising, for each of the one or more potential adjustments to the distribution of replicas among the nodes:
for each of multiple soft goals, determining whether the potential adjustment violates the soft goal;
wherein violation of a hard goal prevents the potential adjustment from being included in the plan; and
wherein violation of a soft goal does not prevent the potential adjustment from being included in the plan.

3. The method of claim 2, wherein the hard goals include:
no more than one replica of a given partition residing on a single rack comprising one or more nodes of the message brokering cluster; and
utilization by a broker of no more than a specified threshold of a given resource.

4. The method of claim 2, wherein the soft goals include:
even distribution, among all nodes, of all replicas of all partitions of a given topic;
even distribution, among all nodes, of all replicas of all partitions of all topics; and
even usage, among all nodes, of a first subset of the set of resources.

5. The method of claim 4, wherein the soft goals further include:
even distribution, among all racks comprising one or more nodes, of a second subset of the set of resources.

6. The method of claim 1, wherein monitoring the nodes' usage of a set of resources comprises:
monitoring the nodes' usage of at least one resource on a per-replica basis.

7. The method of claim 6, wherein monitoring the nodes' usage of a set of resources further comprises:
for each of one or more resources, determining whether a node is using more than a threshold percentage of the node's corresponding capacity.

8. The method of claim 1, wherein detecting an imbalance in the nodes' usage of the set of resources comprises:
receiving from the nodes reports of the nodes' utilization of each resource in the set of resources; and
identifying one or more of:
usage by one node of more than a specified threshold of a given resource; and
a difference in utilization of the given resource, between two or more of the nodes, of at least a threshold amount.

9. An apparatus, comprising:
one or more processors; and
memory storing instructions that, when executed by the one or more processors, cause the apparatus to:
process a stream of messages at a message brokering cluster, wherein:
the message stream is divided into topics;
each topic is divided into multiple partitions; and
replicas of each partition are distributed among a set of nodes within the message brokering cluster;
monitor the nodes' usage of a set of resources;
detect an imbalance in the nodes' usage of the set of resources;
for each of one or more potential adjustments to the distribution of replicas among the nodes:
estimate whether the potential adjustment will alleviate the imbalance; and
determine whether the potential adjustment would violate one or more hard goals for the message brokering cluster; and
execute a plan to adjust the distribution of replicas among the node.

10. The apparatus of claim 9, wherein the memory further stores instructions that, when executed by the one or more processors, cause the apparatus to, for each of the one or more potential adjustments to the distribution of replicas among the nodes:
for each of multiple soft goals, determining whether the potential adjustment violates the soft goal;
wherein violation of a hard goal prevents the potential adjustment from being included in the plan; and
wherein violation of a soft goal does not prevent the potential adjustment from being included in the plan.

11. The apparatus of claim 10, wherein the hard goals include:
no more than one replica of a given partition residing on a single rack comprising one or more nodes of the message brokering cluster; and
utilization by a broker of no more than a specified threshold of a given resource.

12. The apparatus of claim 10, wherein the soft goals include:
even distribution, among all nodes, of all replicas of all partitions of a given topic;
even distribution, among all nodes, of all replicas of all partitions of all topics; and
even usage, among all nodes, of a first subset of the set of resources.

13. The apparatus of claim 12, wherein the soft goals further include:
even distribution, among all racks comprising one or more nodes, of a second subset of the set of resources.

14. The apparatus of claim 9, wherein monitoring the nodes' usage of a set of resources comprises:
monitoring the nodes' usage of at least one resource on a per-replica basis.

15. The apparatus of claim 14, wherein monitoring the nodes' usage of a set of resources further comprises:
for each of one or more resources, determining whether a node is using more than a threshold percentage of the node's corresponding capacity.

16. The apparatus of claim 9, wherein detecting an imbalance in the nodes' usage of the set of resources comprises:
receiving from the nodes reports of the nodes' utilization of each resource in the set of resources; and
identifying one or more of:
usage by one node of more than a specified threshold of a given resource; and
a difference in utilization of the given resource, between two or more of the nodes, of at least a threshold amount.

17. A system, comprising:
one or more processors;
a message brokering module comprising a non-transitory computer-readable medium storing instructions that, when executed, cause the system to process a stream of messages at a message brokering cluster, wherein:
the message stream is divided into topics;
each topic is divided into multiple partitions; and
replicas of each partition are distributed among a set of nodes within the message brokering cluster;
a monitor module comprising a non-transitory computer-readable medium storing instructions that, when executed, cause the system to:
monitor the nodes' usage of a set of resources; and
detect an imbalance in the nodes' usage of the set of resources;
an analyzer module comprising a non-transitory computer-readable medium storing instructions that, when executed, cause the system to, for each of one or more potential adjustments to the distribution of replicas among the nodes:
estimate whether the potential adjustment will alleviate the imbalance; and
determine whether the potential adjustment would violate one or more hard goals for the message brokering cluster; and
an executor module comprising a non-transitory computer-readable medium storing instructions that, when executed, cause the system to execute a plan to adjust the distribution of replicas among the node.

18. The system of claim 17, wherein the computer-readable medium of the analyzer module further stores instructions that, when executed, cause the system to, for each of the one or more potential adjustments to the distribution of replicas among the nodes:
for each of multiple soft goals, determining whether the potential adjustment violates the soft goal;
wherein violation of a hard goal prevents the potential adjustment from being included in the plan; and
wherein violation of a soft goal does not prevent the potential adjustment from being included in the plan.

19. The system of claim 18, wherein the hard goals include:
no more than one replica of a given partition residing on a single rack comprising one or more nodes of the message brokering cluster; and
utilization by a broker of no more than a specified threshold of a given resource.

20. The system of claim 18, wherein the soft goals include:
even distribution, among all nodes, of all replicas of all partitions of a given topic;
even distribution, among all nodes, of all replicas of all partitions of all topics; and
even usage, among all nodes, of a first subset of the set of resources.
